(19) United States
(12) Patent Application Publication
(10) Pub. No.: US 2011/0260965 A1
(43) Pub. Date: Oct. 27, 2011

(54) APPARATUS AND METHOD OF USER INTERFACE FOR MANIPULATING MULTIMEDIA CONTENTS IN VEHICLE

(75) Inventors: Jin Woo KIM, Seongju-gun (KR); Jung Hee LEE, Daejeon (KR)

(73) Assignee: Electronics and Telecommunications Research Institute, Daejeon (KR)

(21) Appl. No.: 12/898,990

(22) Filed: Oct. 6, 2010

(30) Foreign Application Priority Data
Apr. 22, 2010 (KR) 10-2010-0037495

(51) Int. Cl. G09G 5/00

(52) U.S. Cl. 345/156

(57) ABSTRACT

Disclosed are provided an apparatus and a method of a user interface for manipulating multimedia contents for a vehicle. An apparatus of a user interface for manipulating multimedia contents for a vehicle according to an embodiment of the present invention includes: a transparent display module displaying an image including one or more multimedia objects; an ultrasonic detection module detecting a user indicating means by using an ultrasonic sensor in a 3D space close to the transparent display module; an image detection module tracking and photographing the user indicating means; and a head unit judging whether or not any one of the multimedia objects is selected by the user indicating means by using information received from at least one of the image detection module and the ultrasonic detection module and performing a control corresponding to the selected multimedia object.

### CROSS-REFERENCE TO RELATED APPLICATIONS

This application claims priority under 35 U.S.C. §119 to Korean Patent Application No. 10-2010-0037495, filed on Apr. 22, 2010 in the Korean Intellectual Property Office, the disclosure of which is incorporated herein by reference in its entirety.

### BACKGROUND OF THE INVENTION

1. Field of the Invention

The present invention relates to an apparatus and a method of a user interface for manipulating multimedia information in a vehicle, and more particularly, to an apparatus and a method of a user interface for manipulating multimedia contents in a vehicle, which are capable of providing an intuitive interface using a hand in order for a user to safely and efficiently manipulate multimedia information in the vehicle.

2. Description of the Related Art

In recent years, public interest in an automobile fusion technology grafting an IT technology for utilizing infotainment, which includes various information and entertainment in a vehicle has been increasing. Therefore, with standardization of a network and a control technology inside and outside the vehicle, products which enable multimedia to be conveniently used in the vehicle are being released.

As a technology for efficiently controlling the multimedia in the vehicle, a gesture recognition method using a hand becomes the focus. In gesture recognition using the hand, the hand is the most free part among parts of a human body and is the closest to a method for generally handling a tool. Therefore, the gesture recognition using the hand may be the most intuitive interface. As a result, a lot of algorithms which are a source technology of gesture recognition or various applications using gesture recognition are being developed.

However, an environment in the vehicle has different characteristics from general gesture recognition in that a driver which is a main user keeps an eye on a predetermined direction, an operational radius is limited, natural light comes into the entire gesture recognition area through a front window of the vehicle, etc. Accordingly, there is a limit in applying the generally known gesture recognition technology under such a usage environment.

### SUMMARY OF THE INVENTION

The present invention provides an apparatus and a method of a user interface for safely and efficiently manipulating multimedia contents for a multimedia user in a vehicle in addition to a driver.

According to an aspect of the present invention, there is provided an apparatus of a user interface for manipulating multimedia contents for a vehicle that includes: a transparent display module displaying an image including one or more multimedia objects; an ultrasonic detection module detecting a user indicating means by using an ultrasonic sensor in a 3D space close to the transparent display module; an image detection module tracking and photographing the user indicating means; and a head unit judging whether or not any one of the multimedia objects is selected by the user indicating means by using information received from at least one of the image detection module and the ultrasonic detection module and performing a control corresponding to the selected multimedia object.

Herein, the head unit may judge whether or not any one of multimedia objects is selected on the basis of a vector component acquired by using the position of an end point of the hand and the position of the pupil and arrangement and display or not of one or more multimedia objects displayed on the transparent display module are changeable depending on a travelling environment or user's selection.

According to another aspect of the present invention, there is provided an apparatus of a user interface for manipulating multimedia contents for a vehicle that includes: a transparent display displaying an image including one or more multimedia objects; an ultrasonic sensor detecting an object in a 3D space close to the transparent display; a stereo camera stereo-photographing the 3D space; a motion tracker judging whether or not the detected object is a hand and when the object is the hand in accordance with the judgment result, tracking a motion of the hand; a first coordinate detector detecting a first coordinate corresponding to a 3D position of an end point of the hand; a second coordinate detector acquiring 3D coordinates of both user's pupils from the image photographed by the stereo camera and detecting a second coordinate corresponding to a point where an indication vector linking the first coordinate with a center position of the both pupils meets the transparent display; a motion analyzer acquiring a user's gesture from a motion of the hand; an integrator acquiring a final intention of the user by integrating the gesture, the first coordinate, and the second coordinate; and a controller performing predetermined, control depending on the acquired final intention.

According to yet another aspect of the present invention, there is provided a method of a user interface for manipulating multimedia contents for a vehicle that includes: driving an ultrasonic sensor sensing an object in a predetermined 3D space and/or a stereo camera stereo-photographing the 3D space, when an object is detected in a 3D space, verifying whether or not the detected object is a user's hand; detecting a first coordinate which is a 3D coordinate corresponding to an end point of the hand when the object is the hand; detecting 3D coordinates corresponding to both pupils of the user's and detecting a second coordinate corresponding to a point where an indication vector linking the first coordinate with a center position of the both pupils meets a transparent display; acquiring a user's gesture by tracking the hand; acquiring a final intention of the user by integrating the gesture, the first coordinate, and the second coordinate; and performing predetermined control depending on the acquired final intention.

According to an exemplary embodiment of the present invention, there are provided safe and efficient interface apparatus and method suitable to be used in a vehicle without obstructing a user's front view, even when a user manipulates an interface apparatus by controlling a multimedia object through a 3D interface close to a front window.

Further, in the present invention, it is possible to manipulate multimedia contents by using an intuitive interface using a hand and by only indicating a menu to be manipulated without directly touching the menu and as a result, efficiency and safety are further improved.

Furthermore, since the present invention can correspond a coordinate indicated by a user' hand and a sight direction to each other by both interfaces using a hand and an eye, a user can easily control a long-distance object by only indication using the hand while giving a side glance without stretching the hand or using a remote controller, thus, it has high stability.

In the present invention, since a wide display area can be used by attaching a transparent display to a front window of the vehicle, it is possible to circumvent the size of a navigation display of 7 inch or less and improve a sensory effect of multimedia reproduction and in addition, to provide various and a large amount of multimedia information in addition vehicle information to the user even while driving. Further, since it is possible to check a surrounding environment in travelling and control or limit an array of objects displayed depending on the environment, it is possible to provide various information while ensuring the safety.

Besides, the present invention can improve the accuracy of gesture recognition by using both a stereo camera and an ultrasonic sensor and prevent recognition performance from being deteriorated due to ambient lighting.

In addition, a user interface of the present invention can provide a multi-tasking environment for a plurality of multimedia objects and the present invention can be applied for both a driver and other users in the vehicle to use the multi-tasking environment.

### BRIEF DESCRIPTION OF THE DRAWINGS

FIG. 1 is a configuration diagram showing a user interface apparatus for manipulating multimedia contents for a vehicle according to an exemplary embodiment of the present invention;

FIG. 2 is a diagram showing a transparent display module according to an embodiment of the present invention;

FIG. 3 is a diagram showing a 3D space generated by an ultrasonic detection module according to an exemplary embodiment of the present invention;

FIG. 4 is a diagram showing an ultrasonic detection module according to an exemplary embodiment of the present invention;

FIG. 5 is a diagram showing a method for acquiring an indication vector indicating a multimedia object to be controlled by using coordinates of a pupil and a hand's end point according to an exemplary embodiment of the present invention;

FIG. 6 is a configuration diagram showing a user interface apparatus for manipulating multimedia contents for a vehicle according to another exemplary embodiment of the present invention; and

FIG. 7 is a flowchart showing a method of a user interface for manipulating multimedia contents for a vehicle according to yet another exemplary embodiment of the present invention.

### DETAILED DESCRIPTION OF THE PREFERRED EMBODIMENTS

Advantages and characteristics of the present invention, and methods for achieving them will be apparent with reference to embodiments described below in detail in addition to the accompanying drawings. However, the present invention is not limited to the exemplary embodiments to be described below but may be implemented in various forms. Therefore, the exemplary embodiments are provided to enable those skilled in the art to thoroughly understand the teaching of the present invention and to completely inform the scope of the present invention and the exemplary embodiment is just defined by the scope of the appended claims. Meanwhile, ,terms used in the specification are used to explain the embodiments and not to limit the present invention. In the specification, a singular type may also be used as a plural type unless stated specifically. “Comprises” and/or “comprising” used the specification mentioned constituent members, steps, operations and/or elements do not exclude the existence or addition of one or more other components, steps, operations and/or elements.

Hereinafter, preferred embodiments of the present invention will be described in detail with reference to the accompanying drawings.

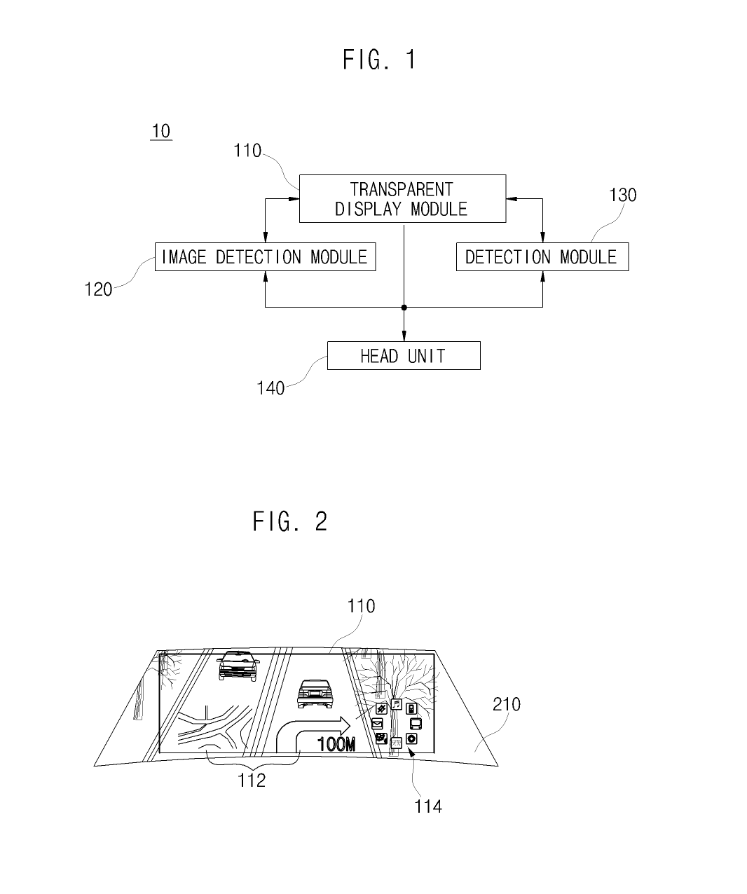

FIG. 1 is a configuration diagram showing a basic configuration of a user interface apparatus for manipulating multimedia contents for a vehicle according to an exemplary embodiment of the present invention.

As shown in FIG. 1, the user interface apparatus 10 for manipulating the multimedia contents for the vehicle according to the embodiment of the present invention includes a transparent display module 110, an image detection module 120, an ultrasonic detection module 130, and a head unit 140.

The transparent display module 110 is mounted on a front window of the vehicle and displays an image including one or more multimedia objects in accordance with the control of the head unit 140. The multimedia object of the specification includes all things represented in various multimedia forms including figures, characters, tables, images, voice, sound, etc. such as a reproduced multimedia object such as music, a moving picture, or the like, menu icons (volume control, etc.) for manipulating the multimedia object, all situation information (e.g., vehicle travelling information in the case in which the present invention is applied to the vehicle) needed for a user, etc. The transparent display module 110 preferably includes a transparent thin film transistor display. However, the transparent display module 110, of course, is not limited thereto.

Examples of the transparent display module 110 and an image displayed thereon are shown in FIG. 2. As shown in FIG. 2, since the transparent display module 110 is mounted on a front window 210 of the vehicle and the transparent display module 110 is transparent, the transparent display module 110 does not obstruct a user's view through the front window. Objects for manipulating multimedia such as a menu icon 112, etc. or various multimedia objects 114 such as navigation information, a reproduced moving picture, etc. may be together displayed on the transparent display module 110.

Meanwhile, the transparent display module 110 is not limited thereto, but the transparent display module 110 preferably may have a 3D conversion function to display a 3D image to the user. In this case, it is possible to provide higher intuitiveness to a multimedia object displayed at a location farther from the user, for example, a right edge of the front window on the basis of the user who sits on a left seat of the vehicle, etc. when the 3D image is displayed to the user than when a 2D image is displayed to the user. That is, it is preferable that the transparent display module 110 has the 3D conversion function so as to manipulate a side object under the same environment as manipulating a front object even when the user stares at the side.

The image detection module 120 is positioned on the top of the front window and performs photographing while tracking a user indicating means such as a user's hand. Further, the image detection module 120 acquires the location of a user's eye to detect an image including a pupil.

The image detection module 120 has a function to track the user indicating means while being rotated at 180 degrees by a servo motor so as to locate the user indicating means within a camera view and is preferably a stereo camera which can acquire a 3D coordinate of the hand or the pupil or enables 3D modeling and reconstruction.

Meanwhile, in this specification, the user indicating means is assumed as the user's hand, but other types of indicating means such as a pointer, etc. may be used as the user indicating means.

An image photographed by the image detection module 120 is transmitted to the head unit 140 to be used as data for determining whether or not the user indicating means enters a detection area or a 3D position of the user's pupil.

The ultrasonic detection module 130 detects motion of the user indicating means in real time within a 3D space close to the transparent display module 110, that is, the detection area by using an ultrasonic sensor.

The ultrasonic detection module 130 is formed to configure n volume elements detected by the ultrasonic sensor in a hexahedral 3D space or a 3D space having a shape similar to a hexahedron in the rear of the front window by arranging a plurality of ultrasonic sensors on the top and bottom and/or the side of the front window.

For example, in FIG. 4, assumed that 10 ultrasonic sensors (Tx, Rx pair) are provided on each of x, y, and z axes (nₓ=n_{y}=n_{z}=10), the number n of volume elements is 10×10×10, that is, 1000.

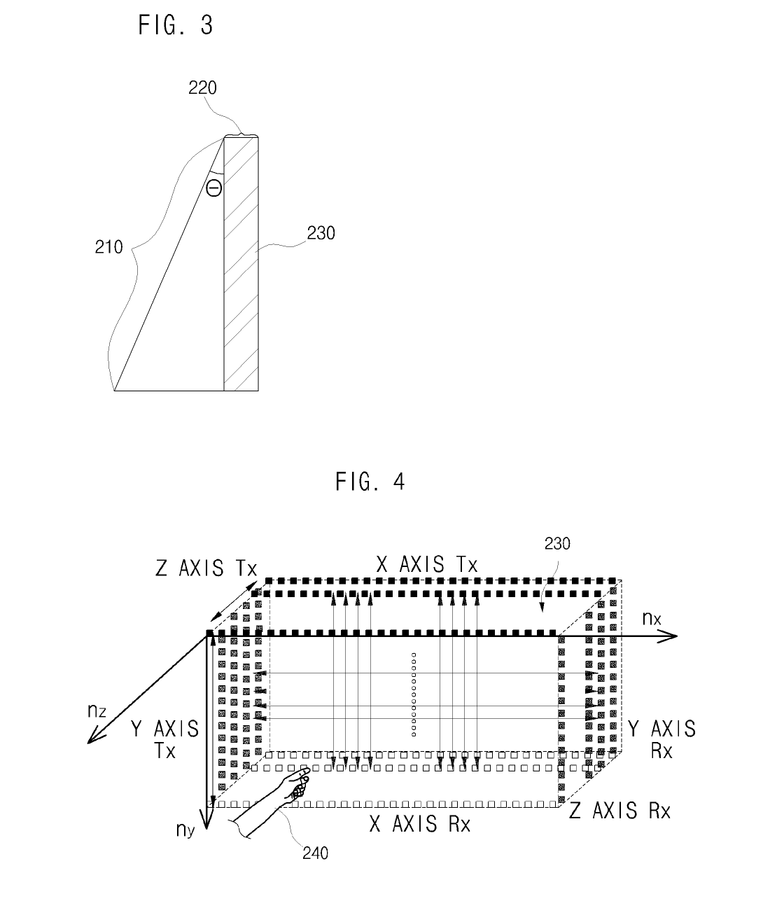

In FIGS. 3 and 4, examples of the 3D space formed by the ultrasonic detection module 130 are shown. FIG. 3 is a diagram showing the 3D space formed by the ultrasonic detection module 130 viewed from the side and FIG. 4 is a diagram showing the 3D space formed by the ultrasonic detection module 130 together with an ultrasonic sensor array.

In the embodiment applied the vehicle, as shown in FIG. 3, a 3D space 230 where the user indicating means is detected by the plurality of ultrasonic sensors is a rectangular parallelepiped space or a space having a shape similar to the rectangular parallelepiped shape vertically formed while forming an angle of θ with the front window 210. Further, this space is a space at which when the user (driver or a person who sits in the passenger seat) stretches his/her hand, a user's hand is positioned.

When the present invention is applied to targets other than the vehicle, a 3D detection area having a shape different from the above shape may be formed.

As shown in FIG. 4, the ultrasonic detection module 130 detects the user indicating means by using the ultrasonic sensor within the 3D space 230 constituted by n (=nₓ*n_{y}*n_{z}) volume elements and transfers the detection result to the head unit 140.

Since the ultrasonic sensor is not influenced by lighting, the ultrasonic sensor has reliability and stability higher than a method of recognizing a hand motion using a camera sensor and the ultrasonic sensor can improve recognition accuracy by being used together with the camera sensor.

The head unit 140 serves to drive various types of multimedia applications such as music, news, multimedia reproduction, navigation, telephone, Internet service, etc. in respect with automotive infotainment and preferably follows the open source-based GENIVI multimedia platform standard.

In the preferred embodiment, the head unit 140 judges what is a control target and/or control operation that is selected by the user indicating means on the basis of the information acquired by the image detection module 120 and the ultrasonic detection module 130 and further performs the selected control in accordance with the judgment result.

Hereinafter, an operation of the head unit 140 relating to selection of the multimedia object will be described in more detail.

The head unit 140 judges whether an object close to the detection area is the user's hand by using two or more images acquired by the image detection module 120 installed on the top of the front window of the vehicle.

As another exemplary embodiment, the head unit 140 may be configured to judge whether or not the object in the detection area is the user indicating means, that is, the hand by using both shape information from the image detection module 120 and information on the shape of an object detected by the ultrasonic detection module 130 in order to improve accuracy and reliability.

That is, since the ultrasonic sensor is not influenced by lighting, the ultrasonic sensor can accurately acquire the shape of the object in the detection area eve in the environment of the vehicle in which natural light comes into the front window to thereby more accurately judge whether or not the user indicating means enters the detection area.

Meanwhile, since the safety of a control device to be used in the vehicle is most important, both the image detection module 120 and the ultrasonic detection module 130 are preferably used in order to acquire an accurate recognition result.

When the object in the detection area is judged as the hand in accordance with the detection result, the head unit 140 acquires 3D information on the shape of the hand from the ultrasonic detection module 130 and reconstructs the shape of the hand in a 3 dimension by using the acquired 3D information.

The ultrasonic detection module 130 forms a 3D detection area constituted by n volume elements by using information of a transmitter and a receiver of an ultrasonic sensor array installed on 3 orthogonal axes of a depth axis z, a width axis x, and a height axis y and detects both a location indicated by the hand and motion of the hand in order to determine a user's desired the control target and a user's desired control operation in the area.

For example, the location indicated by the hand may be used to select a multimedia object which the user wants to control, i.e., an audio file to be reproduced or an object for control and the motion of the hand may be used to specify an operation which the user wants to control.

As a more detailed example, in the case in which the location indicated by the hand is a volume control icon, it may be determined to select the volume control icon with respect to a pressing motion of the hand (e.g., an operation of generally moving the hand toward the object forward within a short time by a short distance) and thereafter, when there is an additional motion of pivoting a wrist in a clockwise or counterclockwise direction while taking a gesture of picking up an object by using a thumb and a forefinger, it may be determined to want a control operation of turning up or down the volume.

The selection and control operations of the multimedia object may be configured by various types, but since it is not directly related to the spirit of the present invention, additional detailed description will be omitted.

Positions of a center point of the hand and an end point of the hand are detected from the detected hand in order to detect the location indicated by the hand and the indicated multimedia object may be determined or the control operations may be acquired by using the information. For example, when the end point of the hand is positioned in a space to which the multimedia object is projected, it may be acquired that the multimedia object is selected and the motion of the hand is acquired by acquiring the positions of the center point of the hand and the end point of the hand to judge a control operation corresponding to the motion of the hand.

The ultrasonic detection module 130 may independently acquire the position and operation of the hand and the ultrasonic detection module 130 may acquire the position and operation of the hand by using image information acquired by the image detection module 120 in order to improve accuracy and reliability. In this case, the image detection module is rotatable by, for example, such that the servo motor it is possible to make a wide motion radius (that is, the detectable motion radius of the hand) of the hand by tracking the hand in real time, easily differentiate the hand from an adjacent image and more minutely acquire the motion of the hand by reducing the size of an adjacent area of an acquired image frame.

As another exemplary embodiment, by acquiring the position of the eye (that is, pupil) or the position of the end point of the hand and selecting the object by using the acquired positions, it is possible to reduce user's motion or efforts which are caused due to selection and manipulation of the object.

That is, in order to select the object by using only the position of the hand, the user should generally stare at the object for a predetermined time. However, the user averts his/her eye to locations other than a front road even for a moment while the user performs a safety-related operation such as vehicle driving, causing an accident and therefore, it is not preferable.

If the user can select and manipulate the object with high accuracy only by giving a side glance or using a user's simple hand motion (the position of the hand and the motion of the hand), the effectiveness of a non-contact multimedia object selection and manipulation environment which is an operation environment of the present invention may be maximized.

For this, the present invention uses both the image detection module 120 and the ultrasonic detection module 130. That is, a 3D position of the user's pupil is detected through a stereo image acquired from the image detection module 120 and 3D positions of the end point of the user's hand is detected through the ultrasonic detection module 130 and thereafter, a 3D indication vector constituted by the two points is acquired and used to select the multimedia object.

Specifically, the head unit 140 detects positional information of two pupils from the stereo image acquired from the image detection module 120. The positional information of each of the pupils in the 3D space may be acquired using a disparity map.

Various methods may be used in order to detect the end point of the hand and for example, the end point of the hand may be detected from the detected hand area by using curvature information. In the case in which the user indicates the multimedia object while spreading out only his/her one finger (i.e., forefinger), only one end point will be detected. Contrary to this, in the case in which the user indicates the multimedia object while spreading out his/her fingers, a plurality of end points may be detected. At this time, the end point may be detected by a method of using an end point of a finger positioned closest to the multimedia object, etc.

Meanwhile, a more reliable method of detecting the end point of the hand will be described below. First, a virtual point which may be determined as the user's eye (more accurately, the middle point between user's both eyes) is designated using the information detected by the ultrasonic detection module 130. The virtual point may be set as the middle point between both eyes detected by the image detection module 120. At this time, the image detection module 120 preferably sets the virtual point from the information acquired by the ultrasonic detection module 130 or sets the virtual point by integrating the information acquired from the image detection module 120 in order to compensate the positions of the eyes and misrecognition generated due to light in image processing.

Thereafter, a point which is the most farthest from the part determined as the hand from the virtual point is regarded as the end point of the hand.

As described above, a method of acquiring the position of the pupil or the position of the end point f the hand in the 3D space by calculating a relative position with two or more feature points (marker) installed at a predetermined position may be used in order to acquire the position of the pupil or the end point of the hand in the 3D space.

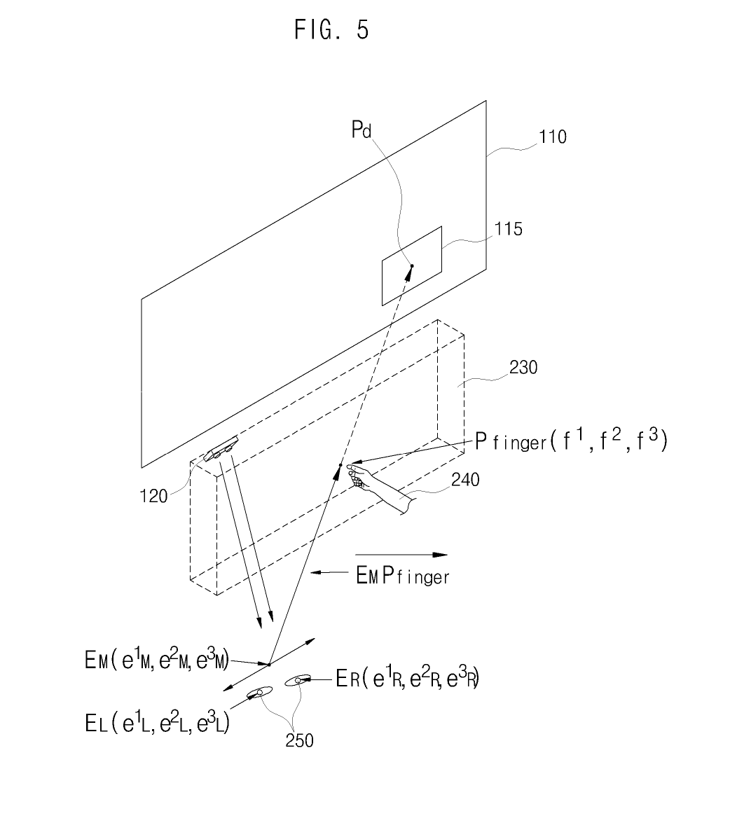

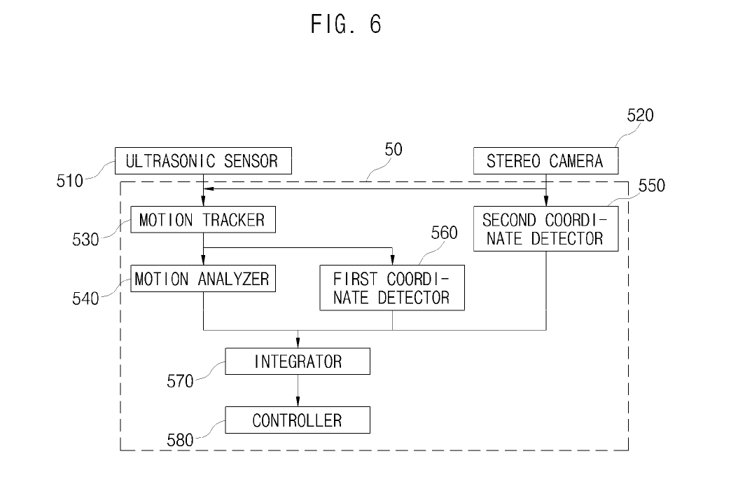

FIG. 5 shows a method of acquiring an indication vector indicating a multimedia object to be controlled by using coordinates of a pupil and an end point of a hand according to an exemplary embodiment of the present invention. Referring to FIG. 5, a process of selecting a 3D multimedia object by using positions of the pupil and the end point of the hand will be described in detail.

The number of human pupils is generally two and when a user indicates an object by using his/her hand, a viewing direction of the user coincides with a vector direction linking the end point of the hand for indication with a center coordinate of two pupils. Therefore, first, a coordinate E_{M}(e¹_{M}, e²_{M}, e³_{M}) of the center position of two pupils is acquired based on positions of 3D coordinates E_{L}(e¹_{L}, e²_{L}, e³_{L}) and E_{R}(e¹_{R}, e²_{R}, e³_{R}) of two pupils 250.

Subsequently, an indication vector E̅_̅{̅M̅}̅P̅_̅{̅f̅i̅n̅g̅e̅r̅}̅ linking an end point P_{finger}(f¹, f², f³) of a hand 240 with the center position E_{M}(e¹_{M}, e²_{M}, e³_{M}) of two pupils is acquired.

Consequently, a multimedia object 115 corresponding to a point P_{d} at which the indication vector intersects the transparent display module 110 is determined as the multimedia object which the user wants to control.

As such, final position information is acquired by acquiring view information from the position of the pupil and combining the acquired view information with the coordinated indicated by the end point of the hand so as for the user to very accurately select the corresponding multimedia object even at the time of indicating the object without directly touching the object with his/her hand while giving a side glance on the multimedia objects displayed on the front window of the vehicle while sitting in a driver's seat.

Meanwhile, a motion of the hand detected in the 3D space formed by the ultrasonic detection module 130 is tracked so as to recognize the direction and gesture of the hand. The motion is tracked by a method of tracking an operational change while comparing the previous frame and the current frame with each other. The motion of the hand is judged through such as process and the user can thus perform multimedia control which the user wants.

Meanwhile, the head unit 140 may verify a surrounding environment in real time during travelling and artificial-intelligently arrange the multimedia objects displayed on the transparent display module 110 or limit the arrangement of the multimedia objects depending on the situation. For example, when the user enters an intersect, it is possible to perform a control not to temporarily display the object or to display the object small in order to secure the user (driver)'s view. Further, a control to display the object differently for each mode by setting different modes during travelling and stopping may be performed.

Although in brief described above, contents of the information displayed on the transparent display module 110 are not limited the multimedia object and may include various information such as navigation information, diagnosis of the vehicle and notification information, etc. Further, in the case in which a communication function is provided in the vehicle, Internet or wireless contents may be displayed. In addition, various information are organically connected with each other so as to control the position and size of the displayed for safety in travelling.

Next, another exemplary embodiment of the head unit of the user interface apparatus of FIG. 1 will be described in detail. FIG. 6 is a configuration diagram showing a configuration of a head unit according to another embodiment of the present invention.

As shown in FIG. 6, the head unit 50 of the user interface apparatus for manipulating multimedia contents for a vehicle includes a motion tracker 530, a first coordinator detector 560, a second coordinate detector 550, a motion analyzer 540, an integrator 570, and a controller 580.

The head unit 50 receives information detected form an ultrasonic sensor 510 and a stereo camera 520. The ultrasonic sensor 510 and the stereo camera 520, which correspond to the ultrasonic detection module 130 and the image detection module 120 of the embodiment of the present invention shown in FIG. 1, respectively, have configurations and functions similar as the modules 120 and 130.

When an object in a 3D space is sensed by the ultrasonic sensor 510, the motion tracker 530 verifies whether or not the sensed object is a user's hand on the basis of shape information acquired from the stereo image and/or ultrasonic sensor.

When the detected object is the user's hand, the motion tracker 530 tracks a motion of the hand by using at least one of the sensing results acquired by the stereo image and the ultrasonic sensor 510.

The first coordinate detector 560 detects a 3D coordinate of an end point of the hand, that is, a first coordinate by detecting the end point of the hand.

The second coordinate detector 550 detects a pupil from a stereo image photographed by the stereo camera 520 and detects a second coordinate corresponding to a point where a vector generated by a center coordinate between two pupils and the end point of the hand intersects a transparent display module. A method of detecting the second coordinate is the same or similar as the method of operating the head unit 140 in the embodiment of FIG. 1.

Herein, the first coordinate detector 560 and the second coordinate detector 550 may calculate the coordinate of the pupil and the coordinate of the end point of the hand in real time and may track the first coordinate and the second coordinate through prediction of an even to happen while tracking the coordinate of the pupil and the coordinate of the end point of the hand and learning a past event.

The motion analyzer 540 acquires a motion of the user's hand, that is, a gesture on the basis of a motion direction of the hand and a motion pattern of the hand. The motion analyzer 540 may be configured to acquire the gesture by comparing the previous frame and the current frame of the shape information acquired by the ultrasonic detection module 130. The integrator 570 acquires a user's final intention by integrating the user's gesture, the first coordinate, and the second coordinate. At this time, the integrator 570 acquires the final intention by integrating a user's gesture, a first coordinate, and a second coordinate that are detected at the same time.

Although the user's final intention may be generally acquired by the user's gesture and the second coordinate, the first coordinate may be used to acquire the user's final intention instead of the second coordinate when the center coordinate between the pupils cannot be acquired.

The controller 580 performs a predetermined control depending on the user's final intention.

Herein, the predetermined control may be related to reproduction of multimedia contents provided in the vehicle, navigation control, vehicle information monitoring, wired/wireless communication control in the vehicle, etc.

In other words, the controller 580 may diagnose the vehicle information and notify the diagnosis result in accordance with a user's request for monitoring the vehicle information and may display vehicle velocity, a handle operation direction, travelling information, or the like.

Meanwhile, the integrator 570 may not consider an item among the gesture, the first coordinate, and the second coordinate, which is set to be excluded by the user in acquiring the final intention.

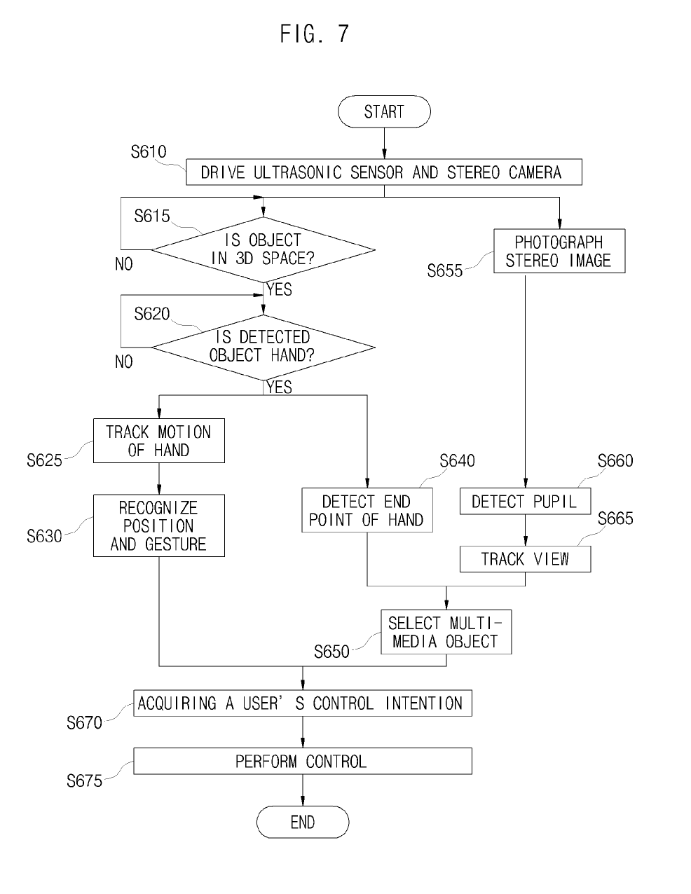

Hereinafter, a method of a user interface for manipulating multimedia contents for a vehicle according to another exemplary embodiment of the present invention will be described. FIG. 7 is a flowchart showing a method of a user interface for manipulating multimedia contents for a vehicle according to another exemplary embodiment of the present invention.

As shown in FIG. 7, when the user interface apparatus 10 for manipulating the multimedia contents for the vehicle is driven, a stereo camera of an image detection module 120 and an ultrasonic sensor of an ultrasonic detection module 130 are driven (S610). Alternately, only the image detection module 120 is first driven to detect a user indicating means in a detection area and thereafter, the ultrasonic detection module 130 may be driven.

The user interface apparatus 10 for manipulating the multimedia contents for the vehicle may be started while the vehicle is driven or may be driven using an additional switch.

A 3D detection area is detected by the ultrasonic detection module 130 or the image detection module 120 to verify whether an object exists in the detection area (S615) and a shape sensed by a stereo image photographed by the stereo camera and/or a shape sensed by the ultrasonic sensor are analyzed to judge whether or not a sensed object is a hand (S620).

When it is judged that the sensed object is the hand, a position of the hand and a motion (gesture) of the hand are recognized by performing 3D modeling and/or reconstruction (3D reconstruction) (S630) while tracking the motion of the hand in real time (S625). Moreover, an end point of the hand is detected (S640) and a target multimedia object is selected on the basis of the detected information (S650). In this specification, the 3D reconstruction represents a process of acquiring actual positions of the hand and a pupil in a 3D space on the basis of a feature point (utilizing a marker in a small-sized closed space) as a reference point. The 3D reconstruction may be a fundamental environment capable of implementing augment reality by virtually spatializing the detection area such as the interior of the vehicle, etc.

In the above process, any one or both of the image detection module 120 and the ultrasonic detection module 130 may be performed.

In the embodiment of the present invention, the multimedia object may be selected and controlled by using only the shape, position, and motion of the hand. Therefore, after selection of the object and the position and motion of the hand are acquired through the above-mentioned process, a user's control intention is acquired on the basis of the information (S670) and a required control is performed (S675). In This case, it is possible to reduce a calculation load and improve accuracy without considering items set to be excluded by the user among the gesture, the first coordinate, and the second coordinate at the time of acquiring a user's final control intention.

Meanwhile, as another exemplary embodiment relating to selection of the multimedia object, in case of selecting the object by using the position of the pupil and the position of the end point of the hand, real-time tracking of the motion of the hand (S625), 3D modeling and reconstruction and recognition of the motion of the hand (S630), and detection of the end point of the hand (S640) are performed in the ultrasonic detection module 130, the image detection module 120 photographs the stereo image (S655), and the pupil is detected from the photographed stereo image (S660), and the multimedia object is selected through the above-mentioned process with reference to FIG. 5 (S650).

Meanwhile, a user's view is tracked (S665) based on photographing of the stereo image (S655) and detection of the pupil (S660) and by the information, the multimedia object may be selected (S650).

That is, since recognition of the eye has an apparent contrast, relatively accurate extraction can be made in spite of influence of light and since the number of drivers is not plural, recognition accuracy can be improved through a pattern or template by using individual data. When processes of predicting an event to happen and learning a past event are added while tracking human eyes (both eyes) in real time on the basis of a display (a reference point of a front window), the user's view may be tracked and the multimedia object may be selected by only tracking the user's view or complementing the tracking in accordance with the view tracking result.

As described above, while the present invention has been shown and described in connection with the exemplary embodiments, it will be apparent to those skilled in the art that modifications and variations can be made without departing from the spirit and scope of the invention as defined by the appended claims.

That is, in the above description, although the information acquired by the image detection module 120 and the ultrasonic detection module 130 are transferred to the head unit 140 without processing, the image detection module 120 or the ultrasonic detection module 130 may directly process some processes performed by the head unit 140.

For example, the image detection module 120 itself may detect the information including the coordinate of the end point of the hand or the coordinate of the pupil and transfer the detected information to the head unit 140 without transferring the detected image itself to the head unit 140. Alternately, the above-mentioned judgment process may be performed by an additional judgment device other than the head unit 140 and various implementation examples may be drawn from contents of the specification by those skilled in the art, but it will be apparent that the modified implementation examples are within the spirit of the present invention.

Accordingly, the scope of present invention is not limited to the above-mentioned embodiment, which will be defined by the appended claims.

What is claimed is:

1. An apparatus of a user interface for manipulating multimedia contents for a vehicle, comprising:
a transparent display module displaying an image including one or more multimedia objects;
an ultrasonic detection module detecting a user indicating means by using an ultrasonic sensor in a 3D space close to the transparent display module;
an image detection module tracking and photographing the user indicating means; and
a head unit judging whether or not any one of the multimedia objects is selected by the user indicating means by using information received from at least one of the image detection module and the ultrasonic detection module and performing a control corresponding to the selected multimedia object.

2. The apparatus of a user interface for manipulating multimedia contents for a vehicle according to claim 1, wherein the transparent display module include a thin film transistor.

3. The apparatus of a user interface for manipulating multimedia contents for a vehicle according to claim 1, wherein the image detection module is rotatable and includes a stereo camera tracking the user indicating means.

4. The apparatus of a user interface for manipulating multimedia contents for a vehicle according to claim 1, wherein the user indicating means is a user's hand and the image detection module photographs an image including the hand and a pupil of the user's.

5. The apparatus of a user interface for manipulating multimedia contents for a vehicle according to claim 4, wherein the head unit judges whether or not any one of the multimedia objects is selected by the user indicating means on the basis of a vector component acquired by using the position of an end point of the hand and the position of the pupil.

6. The apparatus of a user interface for manipulating multimedia contents for a vehicle according to claim 1, wherein the ultrasonic detection module detects a 3D shape, a position, and a motion of the user indicating means by configuring n volume elements detected by the plurality of ultrasonic sensors in the 3D space.

7. The apparatus of a user interface for manipulating multimedia contents for a vehicle according to claim 1, wherein arrangement or display or not of one or more multimedia objects displayed in the transparent display module are changeable depending on a travelling environment of the vehicle and user's selection

8. The apparatus of a user interface for manipulating multimedia contents for a vehicle according to claim 1, wherein the transparent display module displays one or more multimedia objects in a 3D.

9. An apparatus of a user interface for manipulating multimedia contents for a vehicle, comprising:
a transparent display displaying an image including one or more multimedia objects;
an ultrasonic sensor detecting an object in a 3D space close to the transparent display;
a stereo camera stereo-photographing the 3D space;
a motion tracker judging whether or not the detected object is a hand and when the object is the hand in accordance with the judgment result, tracking a motion of the hand;
a first coordinate detector detecting a first coordinate corresponding to a 3D position of an end point of the hand;
a second coordinate detector acquiring 3D coordinates of both user's pupils from the image photographed by the stereo camera and detecting a second coordinate corresponding to a point where an indication vector linking the first coordinate with a center position of the both pupils meets the transparent display;
a motion analyzer acquiring a user's gesture from a motion of the hand;
an integrator acquiring a final intention of the user by integrating the gesture, the first coordinate, and the second coordinate; and
a controller performing predetermined control depending on the acquired final intention.

10. The apparatus of a user interface for manipulating multimedia contents for a vehicle according to claim 9, wherein the plurality of ultrasonic sensors are arranged to form n volume elements in the 3D space.

11. The apparatus of a user interface for manipulating multimedia contents for a vehicle according to claim 9, wherein the motion tracker judges whether or not the detected object is the hand by analyzing the image photographed by the stereo camera or shape information sensed by the ultrasonic sensor.

12. The apparatus of a user interface for manipulating multimedia contents for a vehicle according to claim 9, wherein the motion analyzer acquires the gesture by comparing a previous frame and a current frame of the shape information acquired by the ultrasonic sensor.

13. The apparatus of a user interface for manipulating multimedia contents for a vehicle according to claim 9, wherein the integrator does not consider an item set to be excluded by the user among the gesture, the first coordinate, and the second coordinate at the time of acquiring the final intention.

14. The apparatus of a user interface for manipulating multimedia contents for a vehicle according to claim 9, wherein the integrator integrates the gesture, the first coordinate, and the second coordinate detected at the same time.

15. The apparatus of a user interface for manipulating multimedia contents for a vehicle according to claim 9, wherein the predetermined control is related to at least one of reproduction of multimedia contents provided in the vehicle, navigation control, vehicle information monitoring, and wired/wireless communication control in the vehicle.

16. A method of a user interface for manipulating multimedia contents for a vehicle, comprising:
when an object is detected in a 3D space, verifying whether or not the detected object is a user's hand;
detecting a first coordinate which is a 3D coordinate corresponding to an end point of the hand when the object is the hand;
detecting 3D coordinates corresponding to both pupils of the user's and detecting a second coordinate corresponding to a point where an indication vector linking the first coordinate with a center position of the both pupils meets a transparent display;
acquiring a user's gesture by tracking the hand;
acquiring a final intention of the user by integrating the gesture, the first coordinate, and the second coordinate; and
performing predetermined control depending on the acquired final intention.

17. The method of a user interface for manipulating multimedia contents for a vehicle according to claim 16, wherein at the acquiring a final intention, the gesture, the first coordinate, and the second coordinate detected at the same time are integrated to acquire the final intention of the user.

18. The method of a user interface for manipulating multimedia contents for a vehicle according to claim 16, wherein at the acquiring a final intention, an item set to be excluded by the user is not considered among the gesture, the first coordinate, and the second coordinate.

19. The method of a user interface for manipulating multimedia contents for a vehicle according to claim 16, wherein at the verifying the hand or not, the hand or not is verified by using a stereo image photographed by a stereo camera or shape information sensed by an ultrasonic sensor.

20. The method of a user interface for manipulating multimedia contents for a vehicle according to claim 16, wherein at the acquiring the gesture, the gesture is acquired by comparing a previous frame and a current frame of the shape information acquired by the ultrasonic sensor.
